(19) United States
(12) Patent Application Publication
(10) Pub. No.: US 2005/0083440 A1
(43) Pub. Date: Apr. 21, 2005

(54) Broadcasting service providing system using the point to multi-point connection in ATM network and method therof

(76) Inventor: Myung Jin Kang, Deajeon-si (KR)

Correspondence Address: GRAYBEAL, JACKSON, HALEY LLP, 155 - 108TH AVENUE NE, SUITE 350, BELLEVUE, WA, 98004-5901, US

(21) Appl. No.: 10/746,867

(22) Filed: Dec. 24, 2003

Related U.S. Application Data
(60) Provisional application No. 60/436,713, filed on Dec. 27, 2002.

(51) Int. Cl. H04N 5/38; H04N 7/173

(52) U.S. Cl. 348/723; 725/118; 725/97; 725/95

(57) ABSTRACT

A broadcasting service providing system has an asynchronous transfer mode switch connected to a broadcasting server through a permanent virtual circuit so as to support a point-to-multipoint connection. A single permanent virtual circuit of the broadcasting server is established between the broadcasting server and the asynchronous transfer mode switch for each broadcasting channel and a permanent virtual circuit for broadcasting is established between the asynchronous transfer mode switch and a subscriber. The system has channel zapping message processing equipment to analyze a broadcasting channel zapping message input from the subscriber through the permanent virtual circuit for broadcasting and check multicast group information and subscriber identification information, and broadcasting channel managing equipment to search for permanent virtual circuit information of the broadcasting server corresponding to the multicast group information received from the channel zapping message processing equipment and then return the searched information to the channel zapping message processing equipment.

### CROSS-REFERENCE TO RELATED APPLICATIONS

This application claims priority from U.S. Provisional Patent Application 60/436,713 titled A SYSTEM AND METHOD FOR PROVIDING BROADCASTING SERVICE USING A POINT TO MULTI-POINT CONNECTION IN ATM NETWORK, presently pending, which is hereby incorporated in its entirety by this reference.

### FIELD OF THE INVENTION

The present invention relates to a system and method for providing a broadcasting service using a point-to-multipoint connection in an asynchronous transfer mode (ATM) network and, more particularly, to a system and method for providing a broadcasting service through an ATM switch, which can provide subscribers requiring a same broadcasting channel with a broadcasting program of the broadcasting channel by copying cells using a point-to-multipoint connection in the ATM switch without establishing separate permanent virtual circuits.

### BACKGROUND

An ATM network can provide various multimedia communication services, such as live broadcasting, Video on Demand (VoD), High Definition Television (HDTV) and video conference, as well as communication services, such as low-speed data transmission and voice data transmission which are provided by a conventional communication network through digital subscriber lines (DSLs). Especially, most of the multimedia communication services include the transmission of video images, which have a large amount of data to be transmitted and require a wide bandwidth.

Over the past few years, with the increase of multimedia applications, the amount of multimedia data to be transmitted over a communication network has rapidly increased. A plurality of subscribers desire to be stably provided with broadcasting services, such as the transmission of the video images.

In a conventional apparatus for providing a broadcasting service, the broadcasting service is transmitted to a subscriber terminal from a broadcasting server connected to an ATM network of a digital subscriber line access multiplexer (DSLAM) in a point-to-point connection-type unicast manner. In the case of the broadcasting service provided in the unicast manner, each broadcasting service must be provided to each subscriber terminal. For example, if it is assumed that the broadcasting server provides approximately three broadcasting channels to 20 subscriber terminals in a transmission quality of moving picture experts group 2 (MPEG2) 3 Mbps, a transmission bandwidth of 180 Mbps may be required. Since the transmission bandwidth of 180 Mbps exceeds the bandwidth of STM-1 having a transmission bandwidth of 155 Mbps, a broadcasting service can be smoothly provided to each subscriber terminal only when at least STM-4 having a transmission bandwidth of 622 Mbps is used. As described above, if the broadcasting service is provided using the prior art, transmission bandwidth efficiency for the same channel is rapidly decreased, and the structure of a current digital subscriber line must be changed.

FIG. 1 is a view showing the construction of a conventional ATM-based network for providing a broadcasting service, and FIG. 2 is a view showing a conventional method of providing a broadcasting service.

A broadcasting server 100 for providing broadcasting programs is connected to an ATM switch 110, which is connected to the Internet 180 through a network access system (NAS) 170. The ATM switch 110 and a subscriber are connected to each other through an asymmetric digital subscriber line (ADSL). For this connection, a plurality of digital subscriber line access multiplexers (DSLAM) 120 are connected to the ATM switch. A single DSLAM 120 is connected to a plurality of subscriber premise equipment (xTU-R) 130. Each xTU-R 130 is connected to both a set-top box (STB) 140 and a personal computer (PC) 160. The set-top box 140 is connected to a TV 150. Technology for processing broadcasting cells by the ATM switch 110 of the network having the above configuration is disclosed in Korean Pat. No. 243389 which is directed to a multiplexing apparatus for providing a broadcasting service in an asynchronous transfer mode. Further, a method of controlling television broadcasting calls in an asynchronous transfer mode switching system is disclosed in Korean Pat. No. 101894.

With reference to FIG. 2, the conventional method for providing broadcasting service will be described. When a subscriber A 152 requests a program on channel 1 from the broadcasting server 100, one permanent virtual circuit (PVC) is established between the broadcasting server 100 and the subscriber A 152. The broadcasting server 100 processes a channel zapping signal received from the subscriber terminal, and then broadcasts the program on channel 1 to the subscriber A 152 through the established permanent virtual circuit. Generally, zapping protocols such as digital audio visual council (DAVIC) protocol and internet group management protocol (IGMP) are used as channel zapping protocols. If another subscriber B 154 requests the same program on channel 1 that the subscriber A 152 is watching from the broadcasting server 100, another permanent virtual circuit is established between the broadcasting server 100 and the subscriber B 154, and the program on channel 1 is broadcasted through said another permanent virtual circuit. That is, the conventional broadcasting service providing system using the ATM switch, transmits broadcasting signals by establishing different permanent virtual circuits for respective subscribers between the broadcasting server and the ATM switch even though the subscribers require the same broadcasting channel.

As a result, there are problems in that the efficiency of a transmission bandwidth between the broadcasting server and the switch is decreased, and efficiency according to processing capacity, the allocation of fixed virtual circuits for subscriber terminals and the repeated channel transmission is decreased when the broadcasting server 100 processes channel zapping message signals received from subscriber terminals.

### SUMMARY

Accordingly, the present invention has been made keeping in mind the above problems occurring in the prior art, and thus an object of the present invention is to provide a system and method for providing a broadcasting service through an ATM switch, which can provide subscribers requiring the same broadcasting channel with a broadcasting program of the broadcasting channel by copying cells using a point-to-multipoint connection in the ATM switch without establishing separate permanent virtual circuits.

In order to accomplish the above object, the present invention provides a broadcasting service providing system having an asynchronous transfer mode switch connected to a broadcasting server through a permanent virtual circuit and supporting a point-to-multipoint connection, wherein a single permanent virtual circuit of the broadcasting server is established between the broadcasting server and the asynchronous transfer mode switch for each broadcasting channel, respectively, and a permanent virtual circuit for broadcasting is established between the asynchronous transfer mode switch and a subscriber; and the broadcasting service providing system comprising, channel zapping message processing equipment provided in the asynchronous transfer mode switch to analyze a broadcasting channel zapping message input from the subscriber through the permanent virtual circuit for broadcasting and check multicast group information and subscriber identification information, the channel zapping message processing equipment transmitting a connection establishment or release request including the multicast group information and permanent virtual circuit information of the subscriber corresponding to the subscriber identification information to switching module control equipment when permanent virtual circuit information of the broadcasting server corresponding to the multicast group information is received; and broadcasting channel managing equipment provided in the asynchronous transfer mode switch to search for permanent virtual circuit information of the broadcasting server corresponding to the multicast group information received from the channel zapping message processing equipment and return the searched information to the channel zapping message processing equipment.

Further, the present invention provides a method of providing a broadcasting service in a broadcasting service providing system in which a broadcasting server and an asynchronous transfer mode switch, which supports a point-to-multipoint connection, are connected to each other through a single permanent virtual circuit for each broadcasting channel, respectively, the method comprising the steps of: a) analyzing a broadcasting channel zapping message input from a subscriber through a permanent virtual circuit of the subscriber to check a type of message, multicast group information and subscriber identification information; b) obtaining permanent virtual circuit information of the broadcasting server corresponding to the multicast group information when the message is a join message; c) transmitting the obtained permanent virtual circuit information of the broadcasting server and the permanent virtual circuit information of the subscriber to a switching module control unit of the asynchronous transfer mode switch and transmitting the same broadcasting program transmitted through the same output port in a point-to-multipoint connection manner; d) obtaining permanent virtual circuit information of the broadcasting server corresponding to the multicast group information when the message is a leave message for release of a connection; and e) transmitting the obtained permanent virtual circuit information of the broadcasting server and the permanent virtual circuit information of the subscriber to the switching module control unit of the asynchronous transfer mode switch and releasing the connection.

Further, the present invention provides a computer-readable recording medium for storing a program, which is executed by a computer, the program comprising the steps of: a) analyzing a broadcasting channel zapping message input from a subscriber through a permanent virtual circuit of the subscriber to check a type of message, multicast group information and subscriber identification information; b) obtaining permanent virtual circuit information of a broadcasting server corresponding to the multicast group information when the message is a join message; c) transmitting the obtained permanent virtual circuit information of the broadcasting server and the permanent virtual circuit information of the subscriber to a switching module control unit of an asynchronous transfer mode switch and transmitting the same broadcasting program transmitted through the same output port in a point-to-multipoint connection manner; d) obtaining permanent virtual circuit information of the broadcasting server corresponding to the multicast group information when the message is a leave message for release of a connection; and e) transmitting the obtained permanent virtual circuit information of the broadcasting server and the permanent virtual circuit information of the subscriber to the switching module control unit of the asynchronous transfer mode switch, thus releasing the connection.

### BRIEF DESCRIPTION OF THE DRAWINGS

FIG. 1 is a view showing the construction of a conventional asynchronous transfer mode-based network for providing a broadcasting service,

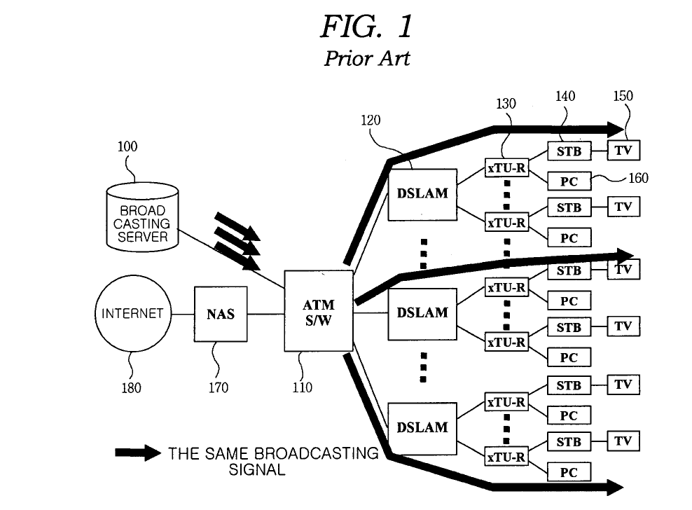

FIG. 2 is a view showing a conventional method of providing a broadcasting service,

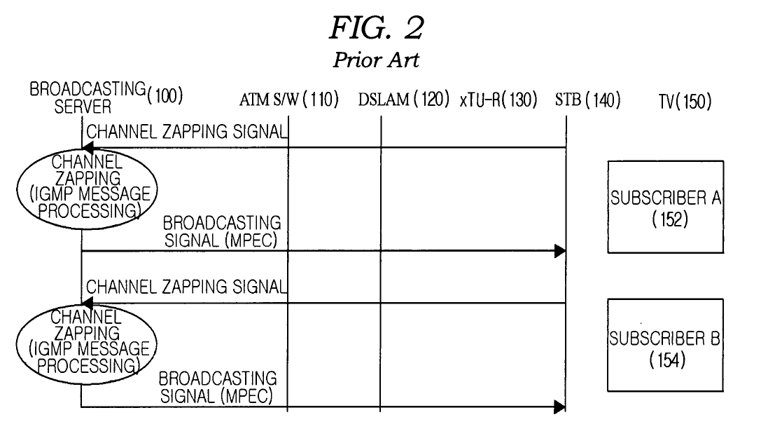

FIG. 3 is a view showing the construction of an asynchronous transfer mode-based network for providing a broadcasting service according to the present invention,

FIG. 4 is a view showing a method of providing a broadcasting service according to the present invention,

FIG. 5 is a block diagram of a broadcasting apparatus according to the present invention, and

FIG. 6 is a flowchart of a method of providing a broadcasting service according to the present invention.

### DETAILED DESCRIPTION

Hereinafter, embodiments of the present invention will be described in detail with reference to the attached drawings.

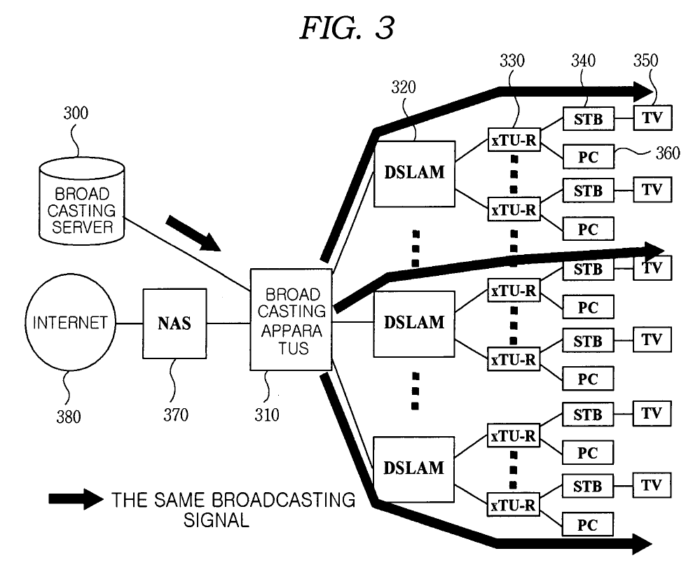

FIG. 3 is a view showing the construction of an ATM-based network for providing a broadcasting service according to the present invention.

In FIG. 3, a difference between the present invention and prior art is that an ATM switch has a function that processes IGMP protocol, which function was performed by a broadcasting server 300 in the prior art, and has a channel management table and a subscriber management table to provide a broadcasting program on channel selected by a subscriber so that a broadcasting program on the same channel may be provided in a point-to-multipoint connection manner.

A single permanent virtual circuit is established between the broadcasting server 300 and a broadcasting apparatus 310 of the present invention with respect to each channel. That is, programs on all channels provided by the broadcasting server 300 are provided to the broadcasting apparatus 310 through the single permanent virtual circuit. Further, a permanent virtual circuit is established between the subscriber and the broadcasting apparatus 310 so as to transmit broadcasting programs and messages for selecting broadcasting channels. Further, the broadcasting apparatus 310 is provided with an ATM switching function of supporting a point-to-multipoint connection and an IGMP protocol processing function for selecting broadcasting channels. Technology relating to the ATM switch supporting the point-to-multipoint connection is disclosed in Korean Laid-Open Publication No. 2001-11135 entitled “Cell copy apparatus for transmitting a point-to-multipoint connected cell and subscriber interface apparatus of asynchronous transfer mode switch using the same”. Therefore, a detailed description of the technology is omitted.

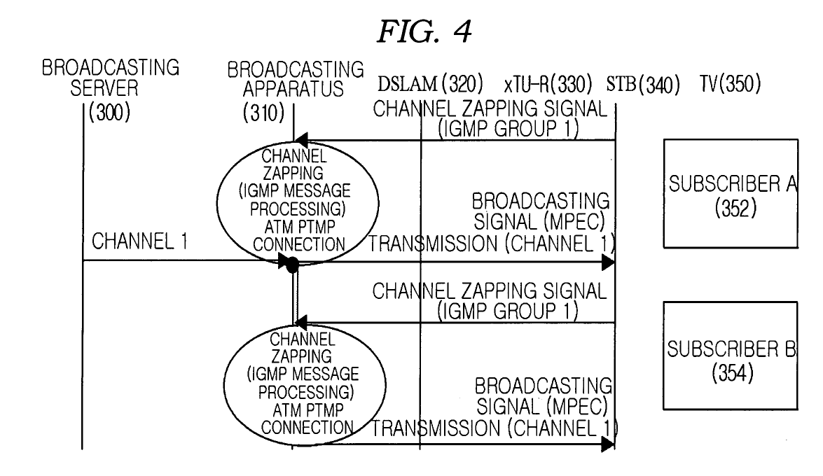

In FIG. 4, a subscriber A 352 and a subscriber B 354 are connected to a same digital subscriber line access multiplexer 320 or different digital subscriber line access multiplexers 320, respectively. If the subscriber A 352 requests a broadcasting channel 1 using the IGMP, the broadcasting apparatus 310 processes the IGMP from the subscriber and connects a permanent virtual circuit of the broadcasting server corresponding to the broadcasting channel 1 to a permanent virtual circuit of the subscriber A 352, thus providing a broadcasting program to the subscriber A 352. If another subscriber B 354 connected to the digital subscriber line access multiplexer 320 requests the same broadcasting channel 1 that the subscriber A 352 is watching, the broadcasting apparatus 310 extracts an IGMP message from an ATM cell, analyzes the IGMP message, and performs a control operation for connecting the permanent virtual circuit corresponding to the broadcasting channel 1 to a permanent virtual circuit of the subscriber B. Then, when destination addresses of the permanent virtual circuits of both the subscribers A and B are the same, the ATM switch transmits video data on broadcasting channel 1 to the subscriber B by copying cells using a point-to-multipoint connection. Technology of supporting the point-to-multipoint connection for a cell proceeding to the same destination in this way is disclosed in detail in the above-mentioned Korean Laid-Open Publication No. 2001-11135.

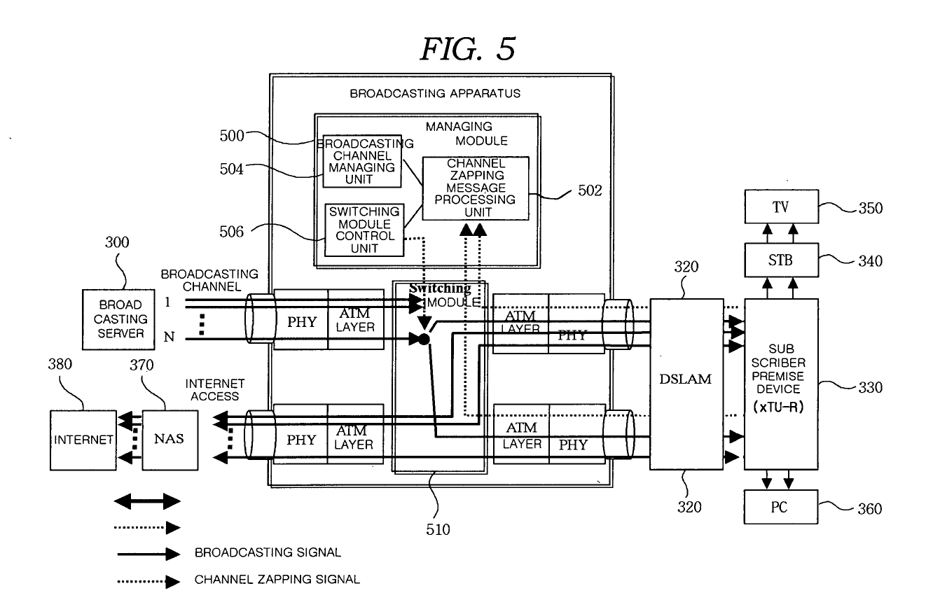

FIG. 5 is a detailed block diagram of the broadcasting apparatus 310 in accordance with the present invention.

In FIG. 5, a physical layer PHY, an ATM layer, a switching module 510, and a switching module control unit 506 are components of a conventional ATM switch. The present invention is implemented to add a channel zapping message processing unit 502 capable of processing IGMP protocol and a broadcasting channel managing unit 504 for mapping a multicast group address to the permanent virtual circuit of the broadcasting server 300, to the ATM switch capable of supporting the point-to-multipoint connection. The channel zapping message processing unit 502, the broadcasting channel managing unit 504 and the switching module control unit 506 belong to a managing module 500.

An ATM cell received through the permanent virtual circuit for a broadcasting service from a subscriber is transmitted to the channel zapping message processing unit 502 that processes an IGMP message. The IGMP protocol uses a host membership query message, a host membership report message, a join message and a leave message. That is, the channel zapping message processing unit 502 analyzes the IGMP message input from the subscriber and then transmits identification information of the subscriber (for example, a permanent virtual circuit number or an IP address) and multicast group information to the broadcasting channel managing unit 504 if the IGMP message is a channel join message or a channel leave message. In this case, the permanent virtual circuit number of the subscriber identification information can be identified from a connection identifier information included in the ATM cell, and the IP address thereof can be identified from the IGMP message because the IP address is included in the IGMP message in the case where the IGMP protocol is used.

The broadcasting channel managing unit 504 manages multicast group information, broadcasting channel information, permanent virtual circuit information of the broadcasting server (information on a permanent virtual circuit connected between the broadcasting server and the ATM switch) corresponding to the broadcasting channel, and information on the subscriber currently connected to the broadcasting channel, in the form of a table. Further, the broadcasting channel managing unit 504 manages permanent virtual circuit information of the subscriber corresponding to an IP address in the form of a table if the subscriber identification information is the IP address. When the multicast group information and the subscriber information are input from the channel zapping message processing unit 502, the broadcasting channel managing unit 504 extracts permanent virtual circuit information of a broadcasting channel corresponding to the multicast group information, changes the subscriber information in the table depending on the joining or leaving of a channel, and transmits the extracted permanent virtual circuit information of the broadcasting server and permanent virtual circuit information of the subscriber to the channel zapping message processing unit 502. When receiving the permanent virtual circuit information of both the broadcasting server and the subscriber from the broadcasting channel managing unit 504, the channel zapping message processing unit 502 transmits the received permanent virtual circuit information and either a join or leave message to the switching module control unit 506, thus either establishing or releasing a connection between the permanent virtual circuits of the broadcasting server and the subscriber.

When receiving the permanent virtual circuit information of both the broadcasting server and the subscriber for connection establishment and release from the channel zapping message processing unit 502, the switching module control unit 506 controls a broadcasting program to be transmitted by copying cells in a point-to-multipoint connection manner if the permanent virtual circuit of the broadcasting server is broadcasted in advance through the same output port in the case of the connection establishment. Further, in the case of the connection release, the switching module control unit 506 releases the connection between the permanent virtual circuits of the broadcasting server and the subscriber. Properly, in the case of the change of a channel, the release and the establishment of the connection between the permanent virtual circuits are performed sequentially.

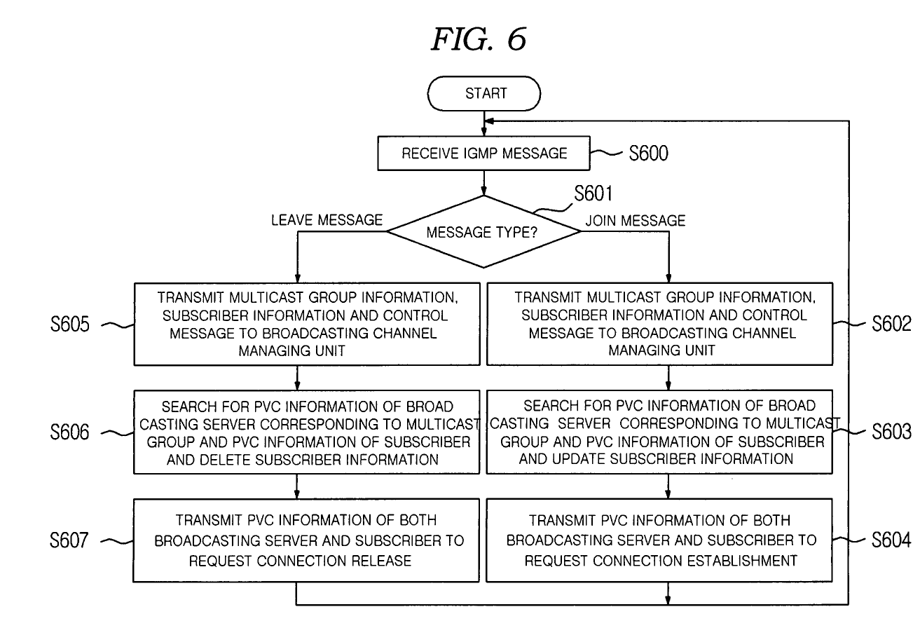

FIG. 6 is a flowchart of a process carried out by the broadcasting apparatus in accordance with the present invention.

If an IGMP message is received through the ATM switching module (step S600), the channel zapping message processing unit 502 analyzes the IGMP message to obtain multicast group information and subscriber identification information included in the message and to check the type of message (step S601). If the message is a join message, the channel zapping message processing unit 502 transmits a join control message to the broadcasting channel managing unit by including the obtained multicast group information and subscriber identification information in the join control message (step S602). The broadcasting channel managing unit searches the table using the multicast group information included in the join control message as a key, registers the subscriber information in a corresponding multicast group table, and returns the permanent virtual circuit (PVC) information of the broadcasting server corresponding to the multicast group information to the channel zapping message processing unit 502 (step S603). In this case, it can be seen that there are various schemes depending on embodiments.

For example, if the permanent virtual circuit information of the subscriber is transmitted to the channel zapping message processing unit 502 from the switch module, only permanent virtual circuit information of the broadcasting server corresponding to the multicast group is required to be transmitted by the broadcasting channel managing unit to the channel zapping message processing unit. However, if subscriber identification information, such as an IP address, is transmitted, the broadcasting channel managing unit or channel zapping message processing unit must manage the permanent virtual circuit information of the subscriber corresponding to the IP address to extract the permanent virtual circuit information of the subscriber.

The channel zapping message processing unit transmits the permanent virtual circuit information of both the broadcasting server and the subscriber, which is received from the broadcasting channel managing unit, to the switching module control unit 506, thus requesting the switching module control unit 506 to establish a connection (step S604). Then, the switching module control unit performs a point-to-multipoint connection by copying cells which are output to the same output port, as described above.

In the meantime, if the received message is a leave message, the channel zapping message processing unit transmits a connection release request message to the broadcasting channel managing unit by including the multicast group information and the subscriber information in the connection release request message (step S605). The broadcasting channel managing unit searches the table using the multicast group information as a key, deletes the subscriber information, and then returns the permanent virtual circuit information of the broadcasting server corresponding to the multicast group information to the channel zapping message processing unit 502 (step S606).

Thereafter, the channel zapping message processing unit 502 transmits the permanent virtual circuit information of both the broadcasting server and the subscriber, received from the broadcasting channel managing unit, to the switching module control unit, thus requesting the switching module control unit to release the connection (step S607).

In the meantime, if the subscriber changes the channel to a channel 2 while watching a channel 1, the set-top box first transmits a leave message and then transmits a join message. Therefore, even in this case, the service method is performed on the basis of the above-described process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the technical scope of protection of the present invention must be defined by the technical spirit of the accompanying claims, and must be analyzed to include all of the above modifications, additions or substitutions.

Accordingly, the present invention establishes only a single permanent virtual circuit with respect to each channel without establishing a permanent virtual circuit between a broadcasting server and an ATM switch whenever a subscriber requests a broadcasting channel, and processes a broadcasting channel requested by a subscriber in a point-to-multipoint connection manner by a broadcasting apparatus including the ATM switch. Therefore, the present invention reduces a transmission bandwidth between the broadcasting server and the ATM switch, and reduces a load generated when the broadcasting server processes a channel zapping message signal from a subscriber terminal, thus providing a broadcasting service through a conventional digital subscriber line without the investment of an additional network.

1. A broadcasting service providing system having an asynchronous transfer mode switch connected to a broadcasting server through a permanent virtual circuit and supporting a point-to-multipoint connection,
wherein a single permanent virtual circuit of the broadcasting server is established between the broadcasting server and the asynchronous transfer mode switch for each broadcasting channel, respectively, and a permanent virtual circuit for broadcasting is established between the asynchronous transfer mode switch and a subscriber; and
the broadcasting service providing system comprising,
channel zapping message processing equipment provided in the asynchronous transfer mode switch to analyze a broadcasting channel zapping message input from the subscriber through the permanent virtual circuit for broadcasting and check multicast group information and subscriber identification information, the channel zapping message processing equipment transmitting a connection establishment or release request including the multicast group information and permanent virtual circuit information of the subscriber corresponding to the subscriber identification information to switching module control equipment when permanent virtual circuit information of the broadcasting server corresponding to the multicast group information is received; and
broadcasting channel managing equipment provided in the asynchronous transfer mode switch to search for permanent virtual circuit information of the broadcasting server corresponding to the multicast group information received from the channel zapping message processing equipment and return the searched information to the channel zapping message processing equipment.

2. The broadcasting service providing system according to claim 1, wherein the channel zapping message processing equipment transmits the multicast group information and the subscriber identification information to the broadcasting channel managing equipment, and the broadcasting channel managing equipment registers or deletes the subscriber identification information in or from a table corresponding to the multicast group information.

3. The broadcasting service providing system according to claim 2, wherein the broadcasting channel managing equipment manages the permanent virtual circuit information of the subscriber corresponding to the subscriber identification information and then returns the permanent virtual circuit information of the subscriber corresponding to the subscriber identification information to the channel zapping message processing equipment.

4. The broadcasting service providing system according to claim 3, wherein the broadcasting channel zapping message is an internet group management protocol (IGMP) message.

5. The broadcasting service providing system according to claim 4, wherein the subscriber identification information is an IP address included in the IGMP message.

6. A method of providing a broadcasting service in a broadcasting service providing system in which a broadcasting server and an asynchronous transfer mode switch, which supports a point-to-multipoint connection, are connected to each other through a single permanent virtual circuit for each broadcasting channel, respectively, the method comprising the steps of:
a) analyzing a broadcasting channel zapping message input from a subscriber through a permanent virtual circuit of the subscriber to check a type of message, multicast group information and subscriber identification information;
b) obtaining permanent virtual circuit information of the broadcasting server corresponding to the multicast group information when the message is a join message;
c) transmitting the obtained permanent virtual circuit information of the broadcasting server and the permanent virtual circuit information of the subscriber to a switching module control unit of the asynchronous transfer mode switch and transmitting the same broadcasting program transmitted through the same output port in a point-to-multipoint connection manner;
d) obtaining permanent virtual circuit information of the broadcasting server corresponding to the multicast group information when the message is a leave message for release of a connection; and
e) transmitting the obtained permanent virtual circuit information of the broadcasting server and the permanent virtual circuit information of the subscriber to the switching module control unit of the asynchronous transfer mode switch and releasing the connection.

7. The broadcasting service providing method according to claim 6, wherein the steps 2) and 4) each comprise the step of obtaining the permanent virtual circuit information of the subscriber corresponding to the subscriber identification information by searching for the permanent virtual circuit information thereof.

8. The broadcasting service providing method according to claim 7, wherein the broadcasting channel zapping message is an internet group management protocol (IGMP) message.

9. The broadcasting service providing method according to claim 8, wherein the subscriber identification information is an IP address included in the IGMP message.

10. A computer-readable recording medium for storing a program, which is executed by a computer, the program comprising the steps of:
a) analyzing a broadcasting channel zapping message input from a subscriber through a permanent virtual circuit of the subscriber to check a type of message, multicast group information and subscriber identification information;
b) obtaining permanent virtual circuit information of a broadcasting server corresponding to the multicast group information when the message is a join message;
c) transmitting the obtained permanent virtual circuit information of the broadcasting server and the permanent virtual circuit information of the subscriber to a switching module control unit of an asynchronous transfer mode switch and transmitting the same broadcasting program transmitted through the same output port in a point-to-multipoint connection manner;
d) obtaining permanent virtual circuit information of the broadcasting server corresponding to the multicast group information when the message is a leave message for release of a connection; and
e) transmitting the obtained permanent virtual circuit information of the broadcasting server and the permanent virtual circuit information of the subscriber to the switching module control unit of the asynchronous transfer mode switch, thus releasing the connection.
